(19) United States
(12) Patent Application Publication
(10) Pub. No.: US 2011/0307258 A1
(43) Pub. Date: Dec. 15, 2011

(54) REAL-TIME APPLICATION OF INTERACTION ANLYTICS

(75) Inventors: Hadas Liberman, Kadima (IL); Keren Eshkol, Harutzim (IL); Oren Lewkowicz, Zur Moshe (IL); Omer Gazit, Ramat Hasharon (IL); Zohar Tzfoni, Tel-Aviv (IL); Avi Revivo, Ramat Hasharon (IL); Leon Portman, Rishon LeZion (IL); Ronit Ephrat, Tel Aviv (IL); Oren Pereg, Amikan (IL); Ronen Laperdon, Modi'in (IL); Dori Shapira, D.N. Sde Gat (IL); Moshe Wasserblat, Maccabim (IL)

(73) Assignee: Nice Systems Ltd., Ra'anana (IL)

(21) Appl. No.: 12/815,429

(22) Filed: Jun. 15, 2010

Related U.S. Application Data
(63) Continuation-in-part of application No. 12/797,618, filed on Jun. 10, 2010.

(51) Int. Cl. G10L 15/04; G06F 15/00

(52) U.S. Cl. 704/251; 704/200; 704/E15.001

(57) ABSTRACT

A method and apparatus for providing real-time assistance related to an interaction associated with a contact center, comprising steps or components for: receiving at least a part of an audio signal of an interaction captured by a capturing device associated with an organization, and metadata information associated with the interaction; performing audio analysis of the at least part of the audio signal, while the interaction is still in progress to obtain audio information; categorizing at least a part of the metadata information and the audio information, to determine a category associated with the interaction, while the interaction is still in progress to obtain audio information; and taking an action associated with the category.

### RELATED APPLICATIONS

This application claims priority from and is a continuation in part of U.S. patent application Ser. No. 12/797,618 titled “Methods and Apparatus for Real-Time Interaction Analysis in Call Centers” filed on Jun. 10, 2010, hereby incorporated by reference in its entirety.

### TECHNICAL FIELD

The present disclosure relates to audio analysis in general, and to a method and apparatus for analyzing audio interactions in real-time, in particular.

### BACKGROUND

Large organizations, such as commercial organizations, financial organizations or public safety organizations conduct numerous interactions with customers, users, suppliers or other persons on a daily basis. A large part of these interactions are vocal, or at least comprise a vocal component.

Speech analytics applications have been used for a few years in analyzing recorded calls. For example, a call is recorded and then analyzed by a speech engine within minutes, hours or days after it has taken place. Such analysis has merits, and can provide significant insight into subjects which are of importance for the organization.

Many of the interactions proceed in a satisfactory manner. The callers receive the information or service they require, and the interaction ends successfully. However, other interactions may not proceed as expected, and some help or guidance from another person such as a supervisor of the handling agent may be required. In even worse scenarios, the agent or another person handling the call may not even be aware that the call is problematic and that some assistance may be helpful. In some cases, when things become clearer, it may already be too late to remedy the situation, and the customer may have already decided to churn the organization.

Similar scenarios may occur in other business interactions, such as unsatisfied customers which do not immediately leave the organization but may do so when the opportunity presents itself, sales interactions in which some help from a supervisor can make the difference between success and failure, or similar cases.

Yet another category in which immediate assistance or observation can make a difference is fraud detection, wherein if a caller is suspected to be fraudulent, then extra care should be taken to avoid operations that are lossy for the organization.

For such situations, analyzing the interactions and determining what needs to be done and the best way to leverage the interaction while the customer is still on the line is beneficial. Early alert or notification can let a supervisor or another person join the interaction or take any other step, when it is still possible to provide assistance, remedy the situation, or otherwise reduce damages.

Real-time analytics can also be instrumental in enabling predictive analytic programs that alter the service and sales paradigm, such that agents having all relevant information can improve and extend customer relationships. Further, when a customer reaches out to an organization, he or she is usually more open to interacting with the organization, e.g., listening to what they organization has to say than a customer on the receiving end of an organization-initiated contact.

There is therefore a need in the art for a method and system that will enable real-time or near-real-time alert or notification about interactions in which there is a need for intervention by a supervisor, or another remedial step to be taken. Such steps may be required for preventing customer chum, keeping customers satisfied, providing support for sales interactions, identifying fraud or fraud attempts, or any other scenario that may pose a problem to a business.

### SUMMARY

A method and apparatus for providing real-time assistance related to an interaction associated with a contact center, comprising steps or components for receiving a full or part of an audio signal of an interaction captured by a capturing device associated with an organization and metadata information associated with the interaction, performing audio analysis of the at least part of the audio signal, while the interaction is still in progress to obtain audio information, categorizing at least a part of the metadata information and the audio information, to determine a category associated with the interaction, while the interaction is still in progress to obtain audio information; and taking an action associated with the category.

One aspect of the disclosure relates to a method for performing a real-time action related to an interaction associated with a contact center, comprising: receiving at least a part of an audio signal of the interaction captured by a capturing device associated with the organization, and metadata information associated with the interaction; performing audio analysis of the at least part of the audio signal, while the interaction is still in progress to obtain audio information; categorizing at least a part of the metadata information and the audio information, to determine a category associated with the interaction, while the interaction is still in progress; and taking an action associated with the category. The method can further comprise an initial categorization step for performing initial categorization of the interaction. Within the method, the initial categorization optionally determines an analysis engine or a parameter of an analysis engine to be used when performing audio analysis of the audio signal. Within the method, the action is optionally selected from the group consisting of: popping a message on a display device of a person participating in the interaction; popping a message on a display device of a supervisor; providing an alert; providing a person participating in the interaction with guidance; providing a supervisor with an option to join the interaction; and calling for help. Within the method, the category optionally relates to a subject selected from the group consisting of: dissatisfied customer; up-sale opportunity; technical assistant; financial mismatch; public safety alarm situation, and an organization-defined issue. Within the method, the audio analysis is optionally selected from the group consisting of: word spotting; emotion analysis; call flow; and transcription. Within the method, the meta data optionally includes an item selected from the group consisting of: Computer Telephony Integration (CTI) data; Customer Relationship Management (CRM) data; start time of the interaction; end time of the interaction; information related to a customer associated with the interaction; information related to a previous interactions between the customer associated with the interaction and the call center; information related to an agent associated with the interaction; and an event occurring an a display device of an agent associated with the interaction. The method can further comprise a step of defining the category.

Another aspect of the disclosure relates to an apparatus for performing a real-time action related to an interaction associated with a contact center, comprising: a logging device for providing at least a part of an audio signal of the interaction captured by a capturing device associated with the organization, and metadata information associated with the interaction; an audio analysis engine for analyzing the at least part of the audio signal, while the interaction is still in progress to obtain audio information; a categorization component for determining a category associated with the interaction in accordance with the metadata information and the audio information, while the interaction is still in progress; and an action manager component for initiating an action associated with the category. Within the apparatus, the analysis engine or a parameter used by the analysis engine thereof optionally depends on initial output of the categorization component. Within the apparatus, the action is optionally selected from the group consisting of: popping a message on a display device of a person participating in the interaction; popping a message on a display device of a supervisor; providing a person participating in the interaction with guidance; providing a supervisor with an option to join the interaction; and calling help. Within the apparatus the category optionally relates to a subject selected from the group consisting of: dissatisfied customer; up-sale opportunity; technical assistant; financial mismatch; public safety alarm situation, and an organization-defined issue. Within the apparatus, the audio analysis engine is optionally selected from the group consisting of: word spotting; emotion analysis; call flow, and transcription. Within the apparatus, the meta data optionally includes an item selected from the group consisting of: Computer Telephony Integration (CTI) data; Customer Relationship Management (CRM) data; start time of the interaction; end time of the interaction; information related to a customer associated with the interaction; information related to a previous interactions between the customer associated with the interaction and the call center; information related to an agent associated with the interaction; and an event occurring an a display device of an agent associated with the interaction.

Yet another aspect of the disclosure relates to a computer readable storage medium containing a set of instructions for a general purpose computer, the set of instructions comprising: receiving at least a part of an audio signal of an interaction captured by a capturing device associated with an organization, and metadata information associated with the interaction; performing audio analysis of the at least part of the audio signal, while the interaction is still in progress to obtain audio information; categorizing at least a part of the metadata information and the audio information, to determine a category associated with the interaction, while the interaction is still in progress; and taking an action associated with the category.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 is a schematic illustration of an apparatus for real-time analytics and a typical environment in which the apparatus is used, in accordance with the disclosure; and

FIG. 2 is a flowchart of the main steps in a method for real-time categorization of interactions and performing actions, in accordance with the disclosure.

### DETAILED DESCRIPTION

The disclosure relates to an apparatus and method for analyzing calls within a call center or another interaction-rich environment. Analysis is based on categorization of the interaction which may use various criteria, parameters, or filters relating to the interaction, as well as information extracted by audio analysis engines from the audio of the interaction. If an interaction complies with the category criteria, the interaction is associated with the category, and a corresponding action defined for the category is taken. The filtering, audio analysis, category assignment, and taking the action are all performed when the interaction is still in progress. The action may instruct the person handling the interaction or another person what to do in order to improve the interaction, or may perform an activity such as notifying or connecting a supervisor, or any other action.

Categorization may be performed in two phases: on an initial categorization phase it, may be determined based on meta data or other characteristics associated with the interaction, whether the interaction potentially complies with the category criteria. If it does, the interaction is transferred to an audio analysis handler which extracts and provides additional data from the interaction itself, such as spotted words, spotted emotional segments or other information.

Optionally, the type or types of audio analysis to be performed upon the interaction, such as word spotting or emotion detection, or parameters associated with the analysis such as the words to be spotted, depend on the particular category identified at the initial categorization.

In another alternative, once a call has been transferred to audio analysis in association with any category, all analyses types are performed, and as widely as possible, e.g., emotion analysis as well as word spotting with all words defined for the organization are performed. This may prove useful if the interaction is eventually not associated with the particular category, and association with another category is attempted.

In yet another embodiment, association is checked against all categories, and the audio analysis types and parameters are determined in accordance with those categories with which the interaction is possibly associated.

Once the audio analysis results or parts thereof are available, it is conclusively determined whether the interaction is indeed associated with the initial category. If the interaction was identified as belonging to multiple categories, then in some embodiments the category with which the interaction has the highest compliance is determined, although in other embodiments any other category can be determined. The action associated with the selected category is then taken.

The initial criteria may relate to parameters such as CTI data, CRM data, start time, end time, duration, the particular agent or the association of the agent to an agent group; extension; call characteristics such as phone number from which the call was initiated, association with a group of numbers, area code, or the like; properties of the recording such as voice quality or compression; call flow events such as transfers or holds; general business data associated with the customer; business data associated with the customer, screen events, or the like.

The products of the audio analysis may relate to words spotted within the interaction and parameters thereof, such as location within the interaction, number of repetitions, proximity to other words or the like. The products of the audio analysis may also relate to emotion detected in the interaction, which may be positive or negative, to any of the participants of the interaction, e.g., the agent or the customer, or to any other characteristic of the audio. The category can relate to any issue or problem associated with or of interest to the organization, for example “up sell”, “customer dissatisfaction”, “predicted churn”, “sales assistance required”, “fraud detected”, or the like.

The action can be, for example, popping a notification comprising an alert, data or suggestion on a display device of the agent or of a another person such as a supervisor, sending a message to the agent or another person, updating a database, sending a message or the like. It will be appreciated that the action can take into account additional events, such as that occurred on the agent's computer or desktop, for example the usage of certain controls or fields being filled.

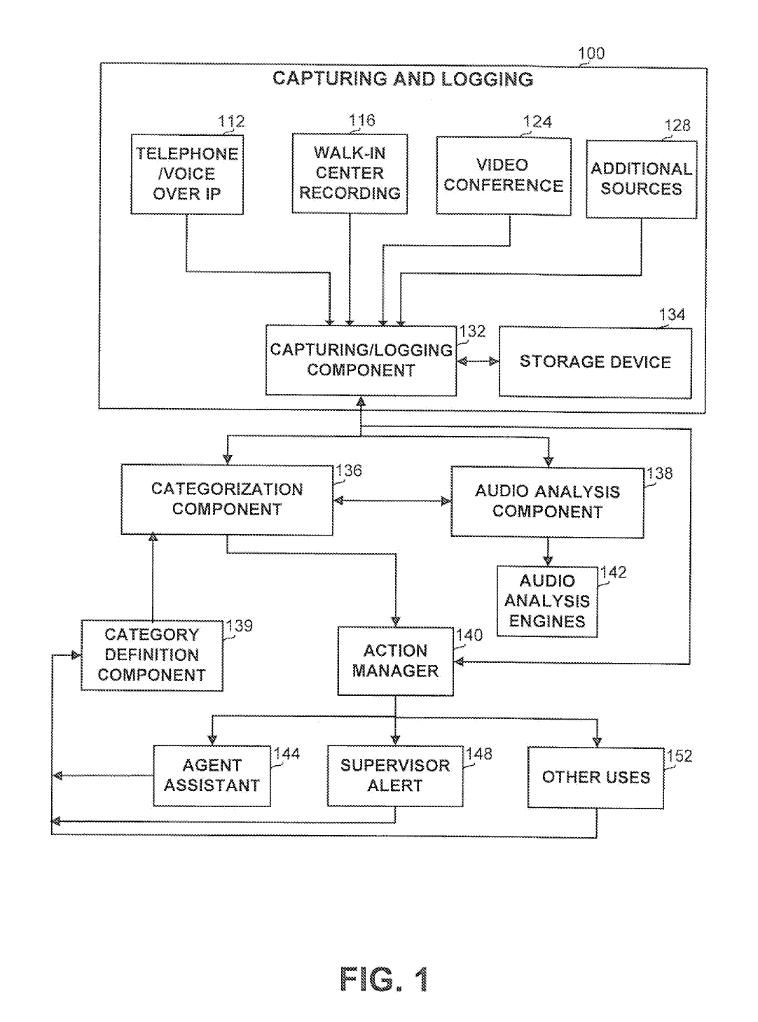

Referring now to FIG. 1, showing a block diagram of the main components in the apparatus and in a typical environment in which the disclosed method and apparatus are used. The environment is preferably an interaction-rich organization, typically a call center, a bank, a trading floor, an insurance company or another financial institute, a public safety contact center, an interception center of a law enforcement organization, a service provider, an internet content delivery company with multimedia search needs or content delivery programs, or the like. Segments, including broadcasts, interactions with customers, users, organization members, suppliers or other parties are captured, thus generating input information of various types. The information types optionally include auditory segments, video segments, textual interactions, and additional data. The capturing of voice interactions, or the vocal part of other interactions, such as video, can employ many forms, formats, and technologies, including trunk side, extension side, summed audio, separate audio, various encoding and decoding protocols such as G729, G726, G723.1, and the like.

The interactions are captured using capturing or logging components 100. The vocal interactions usually include telephone or voice over IP sessions 112. Telephone of any kind, including landline, mobile, satellite phone or others is currently the main channel for communicating with users, colleagues. suppliers, customers and others in many organizations. The voice typically passes through a PABX (not shown), which in addition to the voice of two or more sides participating in the interaction collects additional information discussed below. A typical environment can further comprise voice over IP channels, which possibly pass through a voice over IP server (not shown). It will be appreciated that voice messages are optionally captured and processed as well, and that the handling is not limited to two-sided conversations. The interactions can further include face-to-face interactions, such as those recorded in a walk-in-center 116, video conferences 124 which comprise an audio component, and additional sources of data 128. Additional sources 128 may include vocal sources such as microphone, intercom, vocal input by external systems, broadcasts, files, streams, or any other source. Additional sources may also include non vocal sources such as e-mails, chat sessions, screen events sessions, facsimiles which may be processed by Object Character Recognition (OCR) systems, or others, information from Computer-Telephony-Integration (CTI) systems, information from Customer-Relationship-Management (CRM) systems, or the like. Additional sources 128 can also comprise relevant information from the agent's screen, such as events occurring on the agent's desktop such as entered text, typing into fields, activating controls, or any other data which may be structured and stored as a collection of screen events rather than screen capture.

Data from all the above-mentioned sources and others is captured and may be logged by capturing/logging component 132. Capturing/logging component 132 comprises a computing platform executing one or more computer applications as detailed below. The captured data may be stored in storage 134 which is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured segments and different types of additional data. The storage can be located onsite where the segments or some of them are captured, or in a remote location. The capturing or the storage components can serve one or more sites of a multi-site organization. A part of or storage additional to storage 134 may store data relate to the categorization such as categories, criteria, associated actions, or the like. Storage 134 may also contain data and programs relevant for audio analysis, such as speech models, language models, lists of words to be spotted, or the like.

Categorization component 136 receives data related to the interaction, such as CTI data. CRM data, telephone number of customer or another calling party, extension called, agent, agent group, time, business data, screen events, call flow such as hold or transfer information, or the like. Categorization component 136 analyzes the data and checks it against one or more predefined categories. If the interaction complies with the criteria for one or more categories, it is passed to audio analysis component 13S, which activates one or more audio analysis engines 142, such as but not limited to a word spotting engine which searches the audio for words out of a predetermined list, an emotion detection engine which detects emotional segments within the audio, a transcription engine, talk analysis, part of the call, call segmentation information, or the like. In some embodiments, only engines that can operate relatively fast, i.e., their processing time is a small fraction of the audio duration can be employed, otherwise the results may be received when the interaction is over which is less useful.

In some embodiments, the audio may be streamed to audio analysis component 138 and analyzed as it is being received. In such embodiments, since analysis is much faster than the rate at which the audio is received, one instance of each engine can handle a multiplicity of incoming audio signals which may be captured via multiple channels and time multiplexed.

In other embodiments, the audio may be received as one or more chunks, for example 2-30 seconds chunk, or for example 10 seconds chunks.

In some embodiments, all interactions undergo audio analysis as well as categorization. In other embodiments, only those calls identified by the categorization component as important undergo audio analysis, after which it is determined whether an action should be taken.

It will be appreciated that if all interactions undergo analysis, then some analysis types may be suboptimal. For example, in word spotting analysis, if all interactions undergo word spotting, it is not known a-priori what may be the relevant categories and which list of words should be searched for, therefore all words relevant to the organization are used. If categorization is performed prior to audio analysis, then depending on the category, a relevant shorter list of words may be selected for spotting.

The apparatus further comprises category definition component 139 for defining the categories, including one or more criteria a call has to comply with in order to be associated with the category, including interaction metadata, CRM data, CTI data, or the like, as well as audio analysis data such as spotted words or emotion. The category definition can also include the relevant action to be taken and optional parameters for the action.

Category definition component 139 may require tagging previous interactions, in order to create the relevant categories. Such tagging data can be created manually or in any other manner, and can relate to a particular part of a training interaction, or to the training interaction as a whole.

The results of categorization component 136 are transferred to action manager 140 which determines whether an action should be taken, and if positive, which action.

In some embodiments, action manager 140 can be implemented as part of categorization component, so the action is determined as soon as the categorization result is available.

Action manager 140 can determine to activate any one of the actions associated with the apparatus or with the particular category identified, including but not limited to agent assistant 144, supervisor alert or any other uses 152.

Agent assistant 144 presents the agent with information relevant to the interaction, such as up sell-opportunities, relevant offers, or the like. Agent assistant 144 can also present the agent with an application which will guide him through the interaction. For example in a technical support call, the application can instruct the agent step-by-step in realizing the root of the problem associated with the category, and how to fix it. It will be appreciated that such assistance is most relevant while the interaction is still progressing, and provided that the correct category has been identified, so that the presented solution or offers are indeed relevant.

Supervisor alert component 148 pops up a message or an application on a display device used by a supervisor of the agent. The message or application may be a constant message, or comprise a link that enable the supervisor to join or monitor the interaction; enable the supervisor to listen to relevant areas of the interaction or of previous interactions; present an application which guides the supervisor similarly to the description of agent assistant 144 above; enable the supervisor to instruct the agent without the customer being aware of that for example by sending an instant message, popping a message on the agent's screen, talking to the agent on his earpiece, or the like.

An alert can include for example various graphic alerts such as a screen popup, a vocal indication, an SMS, an e-mail, a textual indication, a vocal indication, or the like. The alert can also include or enable to show information related to on the customer, such as the last predetermine number of interactions with the call center, which agents handled these interactions and which categories they were assigned or should have been assigned to.

The data can also be transferred to other usage component 152 which may include further analysis, for example performing root cause analysis. Additional usage components may also include statistical analysis, playback components, report generation components, or others.

The real-time categorization and analysis results can be further fed back and update the categorization and analysis process.

It will be appreciated that any different, fewer or additional actions can be used for various organizations and environments. Some components can be unified, while the activity of other described components can be split among multiple components. It will also be appreciated that some implementation components. such as process flow components, storage management components, user and security administration components, audio enhancement components, audio quality assurance components or others can be used.

The apparatus may comprise one or more computing platforms, executing components for carrying out the disclosed steps. Each computing platform can be a general purpose computer such as a personal computer, a mainframe computer, or any other type of computing platform that is provisioned with a memory device (not shown), a CPU or microprocessor device, and several I/O ports (not shown). The components are preferably components comprising one or more collections of computer instructions, such as libraries, executables, modules, or the like. programmed in any programming language such as C, C++, C#, Java or others, and developed under any development environment, such as .Net, J2EE or others. Alternatively, the apparatus and methods can be implemented as firmware ported for a specific processor such as digital signal processor (DSP) or microcontrollers, or can be implemented as hardware or configurable hardware such as field programmable gate array (FPGA) or application specific integrated circuit (ASIC). The software components can be executed on one platform or on multiple platforms wherein data can be transferred from one computing platform to another via a communication channel, such as the Internet, Intranet, Local area network (LAN), wide area network (WAN), or via a device such as CDROM, disk on key, portable disk or others.

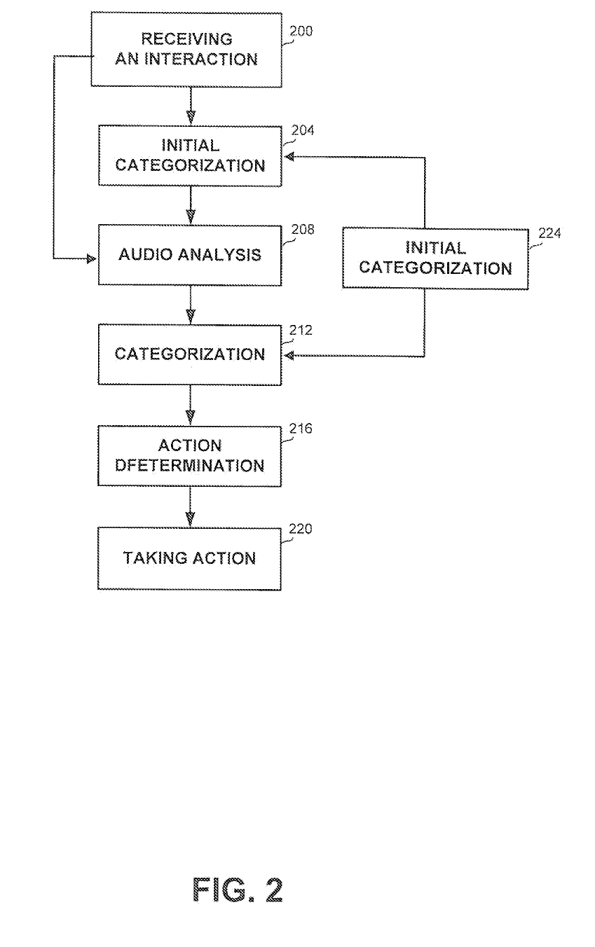

Referring now to FIG. 2, showing a flowchart of the main steps in a method for real time analysis of interactions in a call center, a public safety organization, or any other interaction-rich environment.

On interaction receiving step 200, an interaction to be analyzed is received. The interaction includes the audio data as well as metadata or other information associated with the interaction, such as CTI data, CRM data, identity details of the customer or the interaction, previous interactions of the customer, or any other relevant data. The audio of the interaction can be received as a continuous signal such as a stream, or audio chunks having duration of a number of seconds each.

On optional initial categorization step 204, initial categorization of the interaction is performed in real-time, i.e., while the interaction is still going on, and based upon the meta data or the additional data. For example, a VIP customer may be associated with a different category than an ordinary customer, interactions associated with technical support problems are categorized differently than sale interactions, or the like. In some embodiments, a multiplicity of possible categories can be determined for a particular interaction.

On audio analysis step 208, the audio of the interaction is analyzed by one or more audio analysis engines in real-time.

In some embodiments, it is determined to analyze the audio of an interaction in accordance with the initial categorization results, i.e., based on these results it is determined which audio analysis to perform and with which parameters.

In other embodiments, all interactions are processed by the audio analysis engines. The analysis types and parameters can be predetermined in accordance with a parameter such as agent, agent group, customer identification, or the like.

In yet other embodiments, all interactions can be processed with a fixed set of audio analysis engines and default parameters. In yet another alternative, based on the results extracted by one or more engines, further engines can be activated. For example, if highly emotional segments are detected, word spotting can be performed with anger-related words.

On categorization step 212, the results of initial categorization step 204 and audio analysis step 208 are gathered and a final category is determined in real time for the interaction. If all interactions undergo audio analysis, then initial categorization step 204 can be eliminated, and categorization step 212 is the only categorization step, taking into account all data and meta data associated with the interaction, including the results of audio analysis step 208. If an interaction complies with the criteria for multiple categories, then in some embodiments a single category is determined, either based on a compliance level of the interaction in association with the categories, or selected arbitrarily.

On action determination step 216, an action associated with the category is determined in real-time, and on action step 220 the action is carried out. If multiple actions are associated with the category, then one or more actions are determined in accordance with any parameter associated with the category. Alternatively, multiple actions can be taken. For example, an agent assistant can be presented, as well as presenting a supervisor alert to the supervisor of the agent.

The method may further comprise a category definition step 224 for defining the categories, including the criteria that an interaction has to comply with in order to be associated with the category, including interaction metadata, CRM data, CTI data, or the like, as well as audio analysis data such as spotted words or emotion. The category definition can also comprise the relevant action to be taken and optional parameters for the action.

Some exemplary scenarios may be handled by the disclosed method and apparatus as follows:

When an angry or dissatisfied customer calls a call center regarding goods or services, the customer may use the words “frustrated”, “want to cancel”, or similar words or word combinations. Once a “dissatisfied customer” category has been detected, the supervisor of the agent handling the call receives an alert. The supervisor may then play or monitor the call, see information about the customer and the customer's last interactions, join the call, instruct the agent for example by an instant message, or take any other action or actions.

In another example, a customer may call a contact center inquiring about a new cables offering. Once the “up-sale” category has been detected, the agent may be prompted to ask the customer if he has a TV that supports HD, and if yes to offer him the new HD policy.

In yet another example, a customer may call the contact center and mention a product name and the word problem, wherein the organization may be aware of a functional problem associated with the product. Once the “technical problem” category associated with the particular product has been identified, the system may pop up an alert message to the agent with a link to a technical note on how to solve the problem, or to an application he can use to help the customer.

Another example relates to a situation in the financial world. In which a dealer gets a deal for US dollar but by mistake types HK dollar. When the dealer tries to enter a sum of 100,000,000 US dollars, a categorization system may recognize a “financial mismatch” or a “high sum” situation, and a popup message may appear on the dealer's supervisor's display, indicating an attempt to perform a deal of 100,000,000$.

Yet another situation may relate to public safety. If a “help required” or “alarm situation” category is identified, for example if a shooting sound is identified in the audio, the system may popup a message and alert the agent to get help immediately, or even initiate a call for such help even before the agent had a chance to do so.

Further categories can be defined by organization in accordance with their needs and requirements.

It will be appreciated that the disclosure relates also to a computer readable medium containing instructions for a general purpose computer for executing steps of the disclosed method.

It will be appreciated that multiple other situations, categories, criteria for an interaction to be associated with a category, audio analysis tools and actions can be suggested and used, which combine performing audio analysis and interaction categorization.

It will be appreciated that multiple enhancements can be devised in accordance with the disclosure. For example, multiple different, fewer or additional steps or components can be used. Different ways can be designed for applying the category criteria, and different actions can be taken upon detection of problems.

It will be appreciated by a person skilled in the art that multiple variations and options can be designed along the guidelines of the disclosed methods and system.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation, material, step or component to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. A method for performing a real-time action related to an interaction associated with a contact center, comprising:
receiving at least a part of an audio signal of the interaction captured by a capturing device associated with the organization, and metadata information associated with the interaction;
performing audio analysis of the at least part of the audio signal, while the interaction is still in progress to obtain audio information;
categorizing at least a part of the metadata information and the audio information, to determine a category associated with the interaction, while the interaction is still in progress; and
taking an action associated with the category.

2. The method of claim 1 further comprising an initial categorization step for performing initial categorization of the interaction.

3. The method of claim 2 wherein the initial categorization determines an analysis engine or a parameter of an analysis engine to be used when performing audio analysis of the audio signal.

4. The method of claim 1 wherein the action is selected from the group consisting of popping a message on a display device of a person participating in the interaction; popping a message on a display device of a supervisor; providing an alert; providing a person participating in the interaction with guidance; providing a supervisor with an option to join the interaction; and calling for help.

5. The method of claim 1 wherein the category relates to a subject selected from the group consisting of: dissatisfied customer; up-sale opportunity; technical assistant; financial mismatch; public safety alarm situation, and an organization-defined issue.

6. The method of claim 1 wherein the audio analysis is selected from the group consisting of: word spotting; emotion analysis; call flow, and transcription.

7. The method of claim 1 wherein the meta data includes at least one item selected from the group consisting of: Computer Telephony Integration (CTI) data; Customer Relationship Management (CRM) data; start time of the interaction; end time of the interaction; information related to a customer associated with the interaction; information related to a previous interactions between the customer associated with the interaction and the call center; information related to an agent associated with the interaction; and an event occurring an a display device of an agent associated with the interaction.

8. The method of claim 1 further comprising a step of defining the category.

9. An apparatus for performing a real-time action related to an interaction associated with a contact center, comprising:
a logging device for providing at least a part of an audio signal of the interaction captured by a capturing device associated with the organization, and metadata information associated with the interaction;
an audio analysis engine for analyzing the at least part of the audio signal, while the interaction is still in progress to obtain audio information;
a categorization component for determining a category associated with the interaction in accordance with the metadata information and the audio information, while the interaction is still in progress; and
an action manager component for initiating an action associated with the category.

10. The apparatus of claim 9 wherein the analysis engine or a parameter a parameter used by the analysis engine depends on initial output of the categorization component.

11. The apparatus of claim 9 wherein the action is selected from the group consisting of: popping a message on a display device of a person participating in the interaction; popping a message on a display device of a supervisor; providing a person participating in the interaction with guidance; providing a supervisor with an option to join the interaction; and calling help.

12. The apparatus of claim 9 wherein the category relates to a subject selected from the group consisting of: dissatisfied customer; up-sale opportunity; technical assistant; financial mismatch; public safety alarm situation, and an organization-defined issue.

13. The apparatus of claim 9 wherein the audio analysis engine is selected from the group consisting of: word spotting; emotion analysis; call flow; and transcription.

14. The apparatus of claim 9 wherein the meta data includes at least one item selected from the group consisting of: Computer Telephony Integration (CTI) data; Customer Relationship Management (CRM) data; start time of the interaction; end time of the interaction; information related to a customer associated with the interaction; information related to a previous interactions between the customer associated with the interaction and the call center; information related to an agent associated with the interaction; and an event occurring an a display device of an agent associated with the interaction.

15. A computer readable storage medium containing a set of instructions for a general purpose computer, the set of instructions comprising:
receiving at least a part of an audio signal of an interaction captured by a capturing device associated with an organization, and metadata information associated with the interaction;
performing audio analysis of the at least part of the audio signal, while the interaction is still in progress to obtain audio information;
categorizing at least a part of the metadata information and the audio information, to determine a category associated with the interaction, while the interaction is still in progress; and
taking an action associated with the category.
